(19) United States
(12) Patent Application Publication
(10) Pub. No.: US 2024/0420874 A1
(43) Pub. Date: Dec. 19, 2024

(54) MICROWAVE FERRITE MATERIAL SUITABLE FOR 5G RADIO FREQUENCY DEVICE AND PREPARATION METHOD THEREFOR

(71) Applicant: HENGDIAN GROUP DMEGC MAGNETICS CO., LTD, Dongyang City Jinhua, Zhejiang (CN)

(72) Inventors: Yuanzhen WANG, Dongyang City Jinhua, Zhejiang (CN); Yuhang BAO, Dongyang City Jinhua, Zhejiang (CN); Likang ZHANG, Dongyang City Jinhua, Zhejiang (CN); Feiyu LV, Dongyang City Jinhua, Zhejiang (CN); Yangdong YU, Dongyang City Jinhua, Zhejiang (CN); Yangzhong DU, Dongyang City Jinhua, Zhejiang (CN)

(21) Appl. No.: 18/705,947

(22) PCT Filed: Feb. 22, 2023
(86) PCT No.: PCT/CN2023/077617

§ 371 Date: Apr. 29, 2024

(30) Foreign Application Priority Data
May 9, 2022 (CN) 202210498204.7

(51) Int. Cl. H01F 1/36; C04B 35/26; C04B 35/626; C04B 35/634; C04B 35/64

(52) U.S. Cl. CPC H01F 1/36; C04B 35/2633; C04B 35/2641; C04B 35/6262; C04B 35/6264; C04B 35/62655; C04B 35/62675; C04B 35/6268; C04B 35/62695; C04B 35/63416; C04B 35/64; C04B 2235/3274; C04B 2235/5436; C04B 2235/5445; C04B 2235/5454; C04B 2235/608; C04B 2235/6562; C04B 2235/6567; C04B 2235/6585

(57) ABSTRACT

Disclosed are a microwave ferrite material suitable for a 5G radio frequency device and a preparation method therefor. The preparation raw materials of the microwave ferrite material comprise a first microwave ferrite material and a second microwave ferrite material. In the microwave ferrite material provided by the present application, a double-component formula is introduced, proper ion substitution is employed, and ball milling and sintering processes are controlled, and therefore, the prepared microwave ferrite material has the characteristics of high saturation magnetic moment, high Curie temperature, narrow linewidth and low loss, and can be applied to industrial large-scale production of 5G radio frequency devices.

### TECHNICAL FIELD

Examples of the present application relate to the field of magnetic materials for microwave communications, for example, a microwave ferrite material and a preparation method therefor, and specifically relate to a microwave ferrite material for a 5G radio frequency device and a preparation method therefor.

### BACKGROUND

As the key of microwave ferrite devices, microwave ferrite materials are widely used in microwave ferrite circulators and isolators, which are used in technically processing in the isolation for microwave transmission in microwave systems. Since the volume of ferrite components is much higher than that of other components, the research on miniaturizing and lightweight ferrite components is particularly important. It is extremely crucial to use microwave ferrite materials with small linewidths, low loss, high Curie temperature, and suitable 4πMs for the miniaturization and integration of radio frequency devices.

CN102584200A discloses a microwave ferrite material with ultra-low loss and small linewidth and a preparation method therefor; the main phase of the material has a garnet structure, and the chemical formula is: Y_{3-2x-y}Ca_{2x+y}Fe_{5-x-y-z}VₓZr_{y}Al_{z}O₁₂, wherein 0.02≤x≤0.25, 0.05≤y≤0.25, and 0.01≤z≤0.25; the preparation method comprises the following steps: weighing raw materials according to the calculation based on stoichiometry, vibratory ball milling, pre-sintering, coarse crushing by vibratory milling, fine crushing by sand milling, spray granulation, compress molding, and sintering. The obtained microwave ferrite device has the advantages of wide operating frequency band and low insertion loss. However, the microwave ferrite material requires a high pre-sintering temperature and also a high sintering temperature during the preparation process, thereby increasing energy consumption.

CN112358290A discloses a ferrite material and a preparation method therefor and use thereof. The chemical formula of the ferrite material is Bi_{1.3}Ca_{x+2y}Y_{1.7-x-2y}Fe_{5-x-y}ZrₓW_{y}O₁₂; the x is 0.3-0.4, and the y is 0.01-1. The preparation method comprises the following steps: (1) mixing and sintering raw materials of the ferrite material to obtain a precursor of the ferrite material; (2) mixing the precursors of the ferrite material in step (1) again, and drying, molding, and sintering, so as to obtain the ferrite material. The Bi and Ca elements in the ferrite material are able to partially replace the rare earth Y element, and the Zr and W elements are able to partially replace the Fe ions, and their electromagnetic properties and compensation points are utilized to obtain suitable parameters such as 4πMs, ΔH and Tc. However, the ΔH is close to 50 Oe and the loss still needs to be improved.

In view of the shortcomings of the related art, there is an urgent need to provide a microwave ferrite material with low loss, small linewidth, high saturation magnetic moment, and high Curie temperature.

### SUMMARY

The following is a summary of the subject matter described in detail herein. This summary is not intended to limit the protection scope of the claims.

An embodiment of the present application provides a microwave ferrite material for a 5G radio frequency device and a preparation method therefor; by introducing a two-component formula and controlling a reasonable process design, the resulting microwave ferrite material has a high Curie temperature, high saturation magnetization, narrow linewidth, low loss, and other characteristics.

In a first aspect, an embodiment of the present application provides a microwave ferrite material for 5G radio frequency devices, and raw materials for preparing the microwave ferrite material comprise a first microwave ferrite material and a second microwave ferrite material.

The first microwave ferrite material is: Y_{(3-a-b)}BiₐCa_{b}Fe_{(5-c-d-e-f)}Nb_{c}Zr_{d}InₑMn_{f}O₁₂, wherein 0<a≤0.5, which may be, for example, 0.1, 0.2, 0.3, 0.4, or 0.5, but is not limited to the listed values, and other unlisted values within the numerical range are also applicable;
0<b<1.2, which may be, for example, 0.1, 0.3, 0.5, 0.7, 1.0, or 1.1, but is not limited to the listed values, and other unlisted values within the numerical range are also applicable;
0<c≤0.3, which may be, for example, 0.1, 0.15, 0.2, 0.25, or 0.3, but is not limited to the listed values, and other unlisted values within the numerical range are also applicable;
0<d≤0.6, which may be, for example, 0.1, 0.2, 0.3, 0.4, 0.5, or 0.6, but is not limited to the listed values, and other unlisted values within the numerical range are also applicable;
0<e≤0.6, which may be, for example, 0.1, 0.2, 0.3, 0.4, 0.5, or 0.6, but is not limited to the listed values, and other unlisted values within the numerical range are also applicable;
0<f≤0.6, which may be, for example, 0.1, 0.2, 0.3, 0.4, 0.5, or 0.6, but is not limited to the listed values, and other unlisted values within the numerical range are also applicable; and
b=2c+d−f.

The second microwave ferrite material is: Y_{(3-g-h)}Gd_{g}CaₕFe₍₅₋ᵢ₋ⱼ₋ₖ₋ₙ₎VᵢGeⱼInₖTiₙO₁₂, wherein 0<g≤0.5, which may be, for example, 0.1, 0.2, 0.3, 0.4, or 0.5, but is not limited to the listed values, and other unlisted values within the numerical range are also applicable;
0<h≤1.8, which may be, for example, 0.1, 0.3, 0.5, 0.7, 1, 1.2, 1.4, 1.6, 1.7, or 1.8, but is not limited to the listed values, and other unlisted values within the numerical range are also applicable;
0<i≤0.3, which may be, for example, 0.1, 0.15, 0.2, 0.25, or 0.3, but is not limited to the listed values, and other unlisted values within the numerical range are also applicable;
0<j≤0.6, which may be, for example, 0.1, 0.2, 0.3, 0.4, 0.5, or 0.6, but is not limited to the listed values, and other unlisted values within the numerical range are also applicable;
0<k≤0.6, which may be, for example, 0.1, 0.2, 0.3, 0.4, 0.5, or 0.6, but is not limited to the listed values, and other unlisted values within the numerical range are also applicable;
0<n≤0.6, which may be, for example, 0.1, 0.2, 0.3, 0.4, 0.5, or 0.6, but is not limited to the listed values, and other unlisted values within the numerical range are also applicable; and
h=2i+j+n.

For the microwave ferrite material provided in the present application, Zr⁴⁺ replaces Fe³⁺ at the octahedral site, which reduces the anisotropy constant K₁ and thereby reduces the linewidth; the non-magnetic ion Bi³⁺ replaces Y³⁺ at the dodecahedral site, which increases the dielectric constant of the material and simultaneously reduces the Curie temperature; Nb⁵⁺ replacing Fe³⁺ promotes the substitution of Y³⁺ with Bi³⁺ and inhibits the generation of other phases; the substitution of Fe³⁺ with V⁵⁺ and the substitution of Y³⁺ with Gd³⁺ can improve the 4πMs without lowering the Curie temperature; In can reduce the linewidth of the material, and Mn can inhibit the generation of Fe²⁺ and reduce the dielectric loss of the material.

Preferably, a mass ratio of the first microwave ferrite material to the second microwave ferrite material is (0.5-2): 1, which may be, for example, 0.5:1, 1:1, 1.5:1, or 2:1, but is not limited to the listed values, and other unlisted values within the numerical range are also applicable.

The two-component microwave ferrite material provided in the present application excels in high performance suitable for 5G radio frequency devices through a reasonable ratio of the first microwave ferrite material to the second microwave ferrite material, while an overly high or overly low ratio will cause adverse influence.

In a second aspect, an embodiment of the present application provides a preparation method for the microwave ferrite material as described in the first aspect, and the preparation method comprises the following steps:
(1) mixing the first microwave ferrite material and the second microwave ferrite material in formula proportions, and performing wet ball milling, so as to obtain a mixture;
(2) subjecting the mixture obtained in step (1) to drying, sieving, and granulation sequentially to obtain a ferrite powder; and
(3) subjecting the ferrite powder obtained in step (2) to molding and sintering sequentially to obtain the microwave ferrite material for a 5G radio frequency device.

The preparation method for the microwave ferrite material provided in the present application effectively regulates the activity of the powder and the degree and required temperature of solid-phase reaction by strictly controlling the ball milling period, the medium, and the sintering process, and accordingly, the prepared microwave ferrite material has a high Curie temperature, narrow linewidth, low loss, and other characteristics.

Preferably, a mass ratio of the powder to grinding balls to a grinding aid in the wet ball milling in step (1) is 1:(1-5):(0.6-2.5), which may be, for example, 1:1:0.6, 1:1:0.8, 1:1:1, 1:1:1.5, 1:1:2, 1:1:2.5, 1:1.5:1.5, 1:2:2, 1:3:2, 1:4:2, or 1:5:2.5, but is not limited to the listed values, and other unlisted values within the numerical range are also applicable.

Preferably, the wet ball milling in step (1) is performed for a period of 15-25 h, which may be, for example, 15 h, 18 h, 20 h, 22 h, or 25 h, but is not limited to the listed values, and other unlisted values within the numerical range are also applicable.

Preferably, the wet ball milling in step (1) is performed at a rotational speed of 30-70 r/min, which may be, for example, 30 r/min, 40 r/min, 50 r/min, 60 r/min, or 70 r/min, but is not limited to the listed values, and other unlisted values within the numerical range are also applicable.

Preferably, the grinding balls comprise zirconium balls and/or steel balls.

Preferably, the grinding aid comprises any one or a combination of at least two of deionized water, ethanol, acetone, n-propanol, or aqueous ammonia, and typical but non-limiting combinations comprise a combination of deionized water and alcohol, a combination of acetone and n-propanol, a combination of n-propanol and aqueous ammonia, a combination of deionized water, alcohol, and acetone, a combination of acetone, n-propanol, and aqueous ammonia, a combination of deionized water, ethanol, acetone, and n-propanol, or a combination of deionized water, ethanol, acetone, n-propanol, and aqueous ammonia.

Preferably, the mixture in step (1) has a particle size range: D50: 0.005-2 μm, D90: 0.05-4 μm, and D99: 0.05-4 μm.

The mixture has a particle size range: D50: 0.005-2 μm, which may be, for example, 0.005 μm, 0.01 μm, 0.05 μm, 0.1 μm, 0.5 μm, 1 μm, 1.5 μm, or 2 μm, but is not limited to the listed values, and other unlisted values within the numerical range are also applicable.

The mixture has a particle size range: D90: 0.05-4 μm, which may be, for example, 0.05 μm, 0.1 μm, 0.5 μm, 1 μm, 1.5 μm, 2 μm, 2.5 μm, 3 μm, 3.5 μm, or 4 μm, but is not limited to the listed values, and other unlisted values within the numerical range are also applicable.

The mixture has a particle size range: D99: 0.05-4 μm, which may be, for example, 0.05 μm, 0.1 μm, 0.5 μm, 1 μm, 1.5 μm, 2 μm, 2.5 μm, 3 μm, 3.5 μm, or 4 μm, but is not limited to the listed values, and other unlisted values within the numerical range are also applicable.

Preferably, the drying in step (2) is performed at a temperature of 110-130° C., which may be, for example, 110° C., 115° C., 120° C., 125° C., or 130° C., but is not limited to the listed values, and other unlisted values within the numerical range are also applicable.

Preferably, the drying in step (2) is stopped when a moisture content is reduced to 0.05-5%, which may be, for example, 0.05%, 0.1%, 0.5%, 1%, 2%, 3%, 4%, or 5%, but is not limited to the listed values, and other unlisted values within the numerical range are also applicable.

Preferably, the granulation in step (2) is: mixing a sieved mixture with a binder and then performing sieving under a pressure to obtain the ferrite powder.

Preferably, a mass of the binder is 5-15 wt % of a mass of the mixture, which may be, for example, 5 wt %, 7 wt %, 9 wt %, 11 wt %, 13 wt %, or 15 wt %, but is not limited to the listed values, and other unlisted values within the numerical range are also applicable.

Preferably, the binder comprises an aqueous solution of polyvinyl alcohol.

Preferably, a mass fraction of polyvinyl alcohol is 5-20 wt % in the aqueous solution of polyvinyl alcohol, which may be, for example, 5 wt %, 8 wt %, 10 wt %, 12 wt %, 15 wt %, 18 wt %, or 20 wt %, but is not limited to the listed values, and other unlisted values within the numerical range are also applicable.

Preferably, the pressure is 300-1200 kg/cm², which may be, for example, 300 kg/cm², 500 kg/cm², 800 kg/cm², 1000 kg/cm², or 1200 kg/cm², but is not limited to the listed values, and other unlisted values within the numerical range are also applicable.

Preferably, the sieving is performed with a screen of 30-100 mesh, which may be, for example, 30 mesh, 40 mesh, 50 mesh, 60 mesh, 70 mesh, 80 mesh, 90 mesh, or 100 mesh, but is not limited to the listed values, and other unlisted values within the numerical range are also applicable.

The molding in step (3) has a density of 3-4 g/cm³, which may be, for example, 4 g/cm³, 4 g/cm³, 4 g/cm³, 4 g/cm³, or 4 g/cm³, but is not limited to the listed values, and other unlisted values within the numerical range are also applicable.

Preferably, a blank of the molding in step (3) comprises a cylinder or a cube.

Preferably, the sintering in step (3) is: heating to 1300-1500° C. at a heating rate of 2-5° C./min and holding for 6-20 h.

The sintering is performed at a heating rate of 2-5° C./min, which may be, for example, 2° C./min, 3° C./min, 4° C./min, or 5° C./min, but is not limited to the listed values, and other unlisted values within the numerical range are also applicable.

The sintering is performed by heating to 1300-1500° C., which may be, for example, 1300° C., 1350° C., 1400° C., 1450° C., or 1500° C., but is not limited to the listed values, and other unlisted values within the numerical range are also applicable.

The sintering has a temperature holding period of 6-20 h, which may be, for example, 6 h, 8 h, 10 h, 12 h, 14 h, 16 h, 18 h, or 20 h, but is not limited to the listed values, and other unlisted values within the numerical range are also applicable.

Preferably, for the sintering in step (3), an oxygen introduction is started 1-6 h before the temperature holding ends, which may be, for example, 1 h, 2 h, 3 h, 4 h, 5 h, or 6 h, but is not limited to the listed values, and other unlisted values within the numerical range are also applicable.

Preferably, for the sintering in step (3), the oxygen introduction is stopped when the temperature is 100-500° C. lower than the sintering temperature, which may be, for example, 100° C., 200° C., 300° C., 400° C., or 500° C., but is not limited to the listed values, and other unlisted values within the numerical range are also applicable.

Preferably, the first microwave ferrite material in step (1) is prepared by the following method:
(a) mixing a first raw material in formula proportions, and performing wet ball milling to obtain a mixture; and
(b) subjecting the mixture obtained in step (a) to drying, sieving, and pre-sintering sequentially to obtain the first microwave ferrite material.

Preferably, a mass ratio of the first raw material to grinding balls to a grinding aid to a dispersant in the wet ball milling in step (a) is 1:(1-5):(0.6-2.5):(0.003-0.01), which may be, for example, 1:1:0.6:0.003, 1:1:0.8:0.003, 1:1:1:0.003, 1:1:1.5:0.003, 1:1:2:0.005, 1:1:2.5:0.005, 1:1.5:1.5:0.008, 1:2:2:0.008, 1:3:2:0.01, 1:4:2:0.01, or 1:5:2.5:0.01, but is not limited to the listed values, and other unlisted values within the numerical range are also applicable.

The wet ball milling in step (a) is performed for a period of 15-25 h, which may be, for example, 15 h, 18 h, 20 h, 22 h or 25 h, but is not limited to the listed values, and other unlisted values within the numerical range are also applicable.

Preferably, the wet ball milling in step (a) is performed at a rotational speed of 30-70 r/min, which may be, for example, 30 r/min, 40 r/min, 50 r/min, 60 r/min, or 70 r/min, but is not limited to the listed values, and other unlisted values within the numerical range are also applicable.

Preferably, the first raw material in step (a) comprises Y₂O₃, CaCO₃, Fe₂O₃, ZrO₂, MnCO₃, InO₂, Bi₂O₃, and Nb₂O₅.

Preferably, the grinding balls comprise zirconium balls and/or steel balls.

Preferably, the grinding aid comprises any one or a combination of at least two of deionized water, ethanol, acetone, n-propanol, or aqueous ammonia, and typical but non-limiting combinations comprise a combination of deionized water and alcohol, a combination of acetone and n-propanol, a combination of n-propanol and aqueous ammonia, a combination of deionized water, alcohol, and acetone, a combination of acetone, n-propanol, and aqueous ammonia, a combination of deionized water, ethanol, acetone, and n-propanol, or a combination of deionized water, ethanol, acetone, n-propanol, and aqueous ammonia.

Preferably, the dispersant comprises ammonium citrate and/or aqueous ammonia.

Preferably, the mixture in step (a) has a particle size range: D50: 0.005-2 μm, D90: 0.05-4 μm, and D99: 0.05-4 μm.

The mixture has a particle size range: D50: 0.005-2 μm, which may be, for example, 0.005 μm, 0.01 μm, 0.05 μm, 0.1 μm, 0.5 μm, 1 μm, 1.5 μm, or 2 μm, but is not limited to the listed values, and other unlisted values within the numerical range are also applicable.

The mixture has a particle size range: D90: 0.05-4 μm, which may be, for example, 0.05 μm, 0.1 μm, 0.5 μm, 1 μm, 1.5 μm, 2 μm, 2.5 μm, 3 μm, 3.5 μm, or 4 μm, but is not limited to the listed values, and other unlisted values within the numerical range are also applicable.

The mixture has a particle size range: D99: 0.05-4 μm, which may be, for example, 0.05 μm, 0.1 μm, 0.5 μm, 1 μm, 1.5 μm, 2 μm, 2.5 μm, 3 μm, 3.5 μm, or 4 μm, but is not limited to the listed values, and other unlisted values within the numerical range are also applicable.

Preferably, the drying in step (b) is performed at a temperature of 110-130° C., which may be, for example, 110° C., 115° C., 120° C., 125° C., or 130° C., but is not limited to the listed values, and other unlisted values within the numerical range are also applicable.

Preferably, the drying in step (b) is stopped when a moisture content is reduced to 0.05-5%, which may be, for example, 0.05%, 0.1%, 0.5%, 1%, 2%, 3%, 4%, or 5%, but is not limited to the listed values, and other unlisted values within the numerical range are also applicable.

Preferably, the pre-sintering in step (b) is: heating to 560-1100° C. at a heating rate of 1-2° C./min and holding for 2-12 h.

The pre-sintering is performed at a heating rate of 1-2° C./min, which may be, for example, 1° C./min, 1.2° C./min, 1.5° C./min, 1.8° C./min, or 2° C./min, but is not limited to the listed values, and other unlisted values within the numerical range are also applicable.

The pre-sintering is performed at a temperature of 560-1100° C., which may be, for example, 560° C., 600° C., 700° C., 800° C., 900° C., 1000° C., or 1100° C., but is not limited to the listed values, and other unlisted values within the numerical range are also applicable.

The pre-sintering has a temperature holding period of 2-12 h, which may be, for example, 2 h, 4 h, 6 h, 8 h, 10 h, or 12 h, but is not limited to the listed values, and other unlisted values within the numerical range are also applicable.

Preferably, for the pre-sintering in step (b), an oxygen introduction is started when the temperature reaches the pre-sintering temperature.

Preferably, for the pre-sintering in step (b), the oxygen introduction is stopped when the temperature is 100-200° C. lower than the pre-sintering temperature, which may be, for example, 100° C., 120° C., 150° C., 180° C., or 200° C., but is not limited to the listed values, and other unlisted values within the numerical range are also applicable.

Preferably, the second microwave ferrite material in step (1) is prepared by the following method:
(I) mixing a second raw material in formula proportions, and performing wet ball milling to obtain a mixture; and
(II) subjecting the mixture obtained in step (I) to drying, sieving, and pre-sintering sequentially to obtain the second microwave ferrite material.

Preferably, a mass ratio of the first raw material to grinding balls to a grinding aid to a dispersant in the wet ball milling in step (I) is 1:(1-5):(0.6-2.5):(0.003-0.01), which may be, for example, 1:1:0.6:0.003, 1:1:0.8:0.003, 1:1:1:0.003, 1:1:1.5:0.003, 1:1:2:0.005, 1:1:2.5:0.005, 1:1.5:1.5:0.008, 1:2:2:0.008, 1:3:2:0.01, 1:4:2:0.01, or 1:5:2.5:0.01, but is not limited to the listed values, and other unlisted values within the numerical range are also applicable.

The wet ball milling in step (I) is performed for a period of 15-25 h, which may be, for example, 15 h, 18 h, 20 h, 22 h, or 25 h, but is not limited to the listed values, and other unlisted values within the numerical range are also applicable.

Preferably, the wet ball milling in step (I) is performed at a rotational speed of 30-70 r/min, which may be, for example, 30 r/min, 40 r/min, 50 r/min, 60 r/min, or 70 r/min, but is not limited to the listed values, and other unlisted values within the numerical range are also applicable.

Preferably, the second raw material in step (I) comprises Y₂O₃, CaCO₃, Fe₂O₃, Gd₂O₃, GeO₂, InO₂, TiO₂, and V₂O₅.

Preferably, the grinding balls comprise zirconium balls and/or steel balls.

Preferably, the grinding aid comprises any one or a combination of at least two of deionized water, ethanol, acetone, n-propanol, or aqueous ammonia, and typical but non-limiting combinations comprise a combination of deionized water and alcohol, a combination of acetone and n-propanol, a combination of n-propanol and aqueous ammonia, a combination of deionized water, alcohol, and acetone, a combination of acetone, n-propanol, and aqueous ammonia, a combination of deionized water, ethanol, acetone, and n-propanol, or a combination of deionized water, ethanol, acetone, n-propanol, and aqueous ammonia.

Preferably, the dispersant comprises ammonium citrate and/or aqueous ammonia.

Preferably, the mixture in step (I) has a particle size range: D50: 0.005-2 μm, D90: 0.05-4 μm, and D99: 0.05-4 μm.

The mixture has a particle size range: D50: 0.005-2 μm, which may be, for example, 0.005 μm, 0.01 μm, 0.05 μm, 0.1 μm, 0.5 μm, 1 μm, 1.5 μm, or 2 μm, but is not limited to the listed values, and other unlisted values within the numerical range are also applicable.

The mixture has a particle size range: D90: 0.05-4 μm, which may be, for example, 0.05 μm, 0.1 μm, 0.5 μm, 1 μm, 1.5 μm, 2 μm, 2.5 μm, 3 μm, 3.5 μm, or 4 μm, but is not limited to the listed values, and other unlisted values within the numerical range are also applicable.

The mixture has a particle size range: D99: 0.05-4 μm, which may be, for example, 0.05 μm, 0.1 μm, 0.5 μm, 1 μm, 1.5 μm, 2 μm, 2.5 μm, 3 μm, 3.5 μm, or 4 μm, but is not limited to the listed values, and other unlisted values within the numerical range are also applicable.

Preferably, the drying in step (II) is performed at a temperature of 110-130° C., which may be, for example, 110° C., 115° C., 120° C., 125° C., or 130° C., but is not limited to the listed values, and other unlisted values within the numerical range are also applicable.

Preferably, the drying in step (II) is stopped when a moisture content is reduced to 0.05-5%, which may be, for example, 0.05%, 0.1%, 0.5%, 1%, 2%, 3%, 4%, or 5%, but is not limited to the listed values, and other unlisted values within the numerical range are also applicable.

Preferably, the pre-sintering in step (II) is: heating to 560-1100° C. at a heating rate of 1-2° C./min and holding for 2-12 h.

The pre-sintering is performed at a heating rate of 1-2° C./min, which may be, for example, 1° C./min, 1.2° C./min, 1.5° C./min, 1.8° C./min, or 2° C./min, but is not limited to the listed values, and other unlisted values within the numerical range are also applicable.

The pre-sintering is performed at a temperature of 560-1100° C., which may be, for example, 560° C., 600° C., 700° C., 800° C., 900° C., 1000° C., or 1100° C., but is not limited to the listed values, and other unlisted values within the numerical range are also applicable.

The pre-sintering has a temperature holding period of 2-12 h, which may be, for example, 2 h, 4 h, 6 h, 8 h, 10 h, or 12 h, but is not limited to the listed values, and other unlisted values within the numerical range are also applicable.

Preferably, for the pre-sintering in step (II), an oxygen introduction is started when the temperature reaches the pre-sintering temperature.

Preferably, for the pre-sintering in step (II), the oxygen introduction is stopped when the temperature is 100-200° C. lower than the pre-sintering temperature, which may be, for example, 100° C., 120° C., 150° C., 180° C., or 200° C., but is not limited to the listed values, and other unlisted values within the numerical range are also applicable.

As a preferred technical solution for the preparation method as described in the second aspect of the present application, the preparation method comprises the following steps:
(1) mixing the first microwave ferrite material and the second microwave ferrite material in formula proportions, and performing wet ball milling at 30-70 r/min for 15-25 h, so as to obtain a mixture; a mass ratio of powder material to grinding balls to a grinding aid in the wet ball milling is 1:(1-5):(0.6-2.5); the mixture obtained has a particle size range: D50: 0.005-2 μm, D90: 0.05-4 μm, and D99: 0.05-4 μm;
(2) drying the mixture obtained in step (1) at 110-130° C. until a moisture content is reduced to 0.05-5%, sieving and then granulating; the granulation is: mixing a sieved mixture with a binder, and then performing sieving under a pressure of 300-1200 kg/cm² with a screen of 30-100 mesh to obtain a ferrite powder; and
(3) subjecting the ferrite powder obtained in step (2) to molding and sintering sequentially to obtain the microwave ferrite material for a 5G radio frequency device; the molding has a density of 3-4 g/cm³; the sintering is: heating to 1300-1500° C. at a heating rate of 2-5° C./min and holding for 6-20 h; for the sintering, an oxygen introduction is started 1-6 h before the temperature holding ends; for the sintering, the oxygen introduction is stopped when the temperature is 100-500° C. lower than the sintering temperature;
   the first microwave ferrite material in step (1) is prepared by the following method:
   (a) mixing a first raw material in formula proportions, and performing wet ball milling at 20-80 r/min for 10-40 h to obtain a mixture; a mass ratio of the first raw material to grinding balls to a grinding aid to a dispersant in the wet ball milling is 1:(1-5):(0.6-2.5):(0.003-0.01); the mixture has a particle size range: D50: 0.005-2 μm, D90: 0.05-4 μm, and D99: 0.05-4 μm; and
   (b) drying the mixture obtained in step (a) at 110-130° C. until a moisture content is reduced to 0.05-5%, sieving, and then heating to 560-1100° C. at 1-2° C./min to perform pre-sintering and holding for 2-12 h, so as to obtain the first microwave ferrite material; for the pre-sintering, an oxygen introduction is started when the temperature reaches the pre-sintering temperature; for the pre-sintering, the oxygen introduction is stopped when the temperature is 100-200° C. lower than the pre-sintering temperature;
      the second microwave ferrite material in step (1) is prepared by the following method:
   (I) mixing a second raw material in formula proportions, and performing wet ball milling at 20-80 r/min for 10-40 h to obtain a mixture; a mass ratio of the second raw material to grinding balls to a grinding aid to a dispersant in the wet ball milling is 1:(1-5):(0.6-2.5):(0.003-0.01); the mixture has a particle size range: D50: 0.005-2 μm, D90: 0.05-4 μm, and D99: 0.05-4 μm; and
   (II) drying the mixture obtained in step (I) at 110-130° C. until a moisture content is reduced to 0.05-5%, sieving, and then heating to 560-1100° C. at 1-2° C./min to perform pre-sintering and holding for 2-12 h, so as to obtain the second microwave ferrite material; for the pre-sintering, an oxygen introduction is started when the temperature reaches the pre-sintering temperature; for the pre-sintering, the oxygen introduction is stopped when the temperature is 100-200° C. lower than the pre-sintering temperature.

Compared with the related art, the embodiments of the present application have the following beneficial effects:
the microwave ferrite material provided by the examples of the present application is prepared by introducing a two-component formula, which employs suitable ions for substitution, and by controlling the ball milling and sintering process simultaneously to obtain the microwave ferrite material; for the microwave ferrite material provided by the present application, the saturation magnetization 4πMs reaches up to 1860 Gs, the dielectric constant ε is 13.8 or more, the dielectric loss tgδₑ is less than or equal to 2.2×10⁻⁴, the Curie temperature reaches up to 275° C., and the resonance linewidth ΔH is no more than 23 Oe. The microwave ferrite material provided in the present application can satisfy the miniaturization and lightweight requirements of 5G radio frequency devices and can be applied to industrial mass production.

Other aspects can be understood upon reading and appreciating the detailed description.

### DETAILED DESCRIPTION

The technical solutions of the present application are further described below in terms of specific embodiments. It should be clear to those skilled in the art that the examples are merely used for a better understanding of the present application and should not be construed as a specific limitation to the present application.

### Example 1

This example provides a microwave ferrite material for a 5G radio frequency device, raw materials for preparing the microwave ferrite material comprise a first microwave ferrite material and a second microwave ferrite material; the first microwave ferrite material is: Y_{(3-a-b)}BiₐCa_{b}Fe_{(5-c-d-e-f)}Nb_{c}Zr_{d}InₑMn_{f}O₁₂, wherein a=0.3, b=0.45, c=0.1, d=0.3, e=0.3, and f=0.05; the second microwave ferrite material is: Y_{(3-g-h)}Gd_{g}CaₕFe₍₅₋ᵢ₋ⱼ₋ₖ₋ₙ₎VᵢGeⱼInₖTiₙO₁₂, wherein g=0.4, h=0.75, i=0.2, j=0.3, k=0.3, and n=0.05.

A preparation method for the microwave ferrite material comprises the following steps:
(1) the first microwave ferrite material and the second microwave ferrite material were mixed in a mass ratio of 1:1, and subjected to wet ball milling at 50 r/min for 20 h to obtain a mixture; a mass ratio of powder material to zirconium balls to deionized water in the wet ball milling was 1:1:0.8; the mixture obtained had a particle size: D50: 1 μm, D90: 2 μm, and D99: 3.2 μm;
(2) the mixture obtained in step (1) was dried at 120° C. until the moisture content was reduced to 1%, sieved, and then granulated; the granulation was a process that the sieved mixture was mixed with a 12 wt % aqueous solution of polypropylene alcohol, wherein the mass of the aqueous solution of polypropylene alcohol was 10 wt % of the mass of the dried mixture, and then sieved under a pressure of 700 kg/cm² with a 60-mesh screen, so as to obtain a ferrite powder; and
(3) the ferrite powder in step (2) was sequentially molded and sintered to obtain the microwave ferrite material for a 5G radio frequency device; the molding had a density of 3.5 g/cm³; the sintering was heating to 1400° C. at a heating rate of 3° C./min and holding for 12 h; for the sintering, an oxygen introduction was started 3 h before the temperature holding ended; for the sintering, the oxygen introduction was stopped when the temperature was 300° C. lower than the sintering temperature;
   the first microwave ferrite material in step (1) is prepared by the following method:
(a) a first raw material (Y₂O₃, CaCO₃, Fe₂O₃, ZrO₂, MnCO₃, InO₂, Bi₂O₃, and Nb₂O₅) were mixed in formula proportions, and subjected to wet ball milling at 50 r/min for 20 h to obtain a mixture; a mass ratio of the first raw material to zirconium balls to deionized water to ammonium citrate in the wet ball milling was 1:1:0.8:0.005; the mixture had a particle size: D50: 1 μm, D90: 2 μm, and D99: 3.2 μm; and
(b) the mixture obtained in step (a) was dried at 120° C. until the moisture content was reduced to 1%, sieved, and then pre-sintered by being heated to 800° C. at 1.5° C./min and held for 8 h, so as to obtain the first microwave ferrite material; for the pre-sintering, an oxygen introduction was started when the temperature reached the pre-sintering temperature; for the pre-sintering, the oxygen introduction was stopped when the temperature was 150° C. lower than the pre-sintering temperature;
   the second microwave ferrite material in step (1) is prepared by the following method:
(I) a second raw material (Y₂O₃, CaCO₃, Fe₂O₃, Gd₂O₃, GeO₂, InO₂, TiO₂, and V₂O₅) were mixed in formula proportions, and subjected to wet ball milling at 50 r/min for 20 h to obtain a mixture; a mass ratio of the second raw material to zirconium balls to deionized water to ammonium citrate in the wet ball milling was 1:1:0.8:0.005; the mixture had a particle size: D50: 1 μm, D90: 2 μm, and D99: 3.2 μm; and
(II) the mixture obtained in step (I) was dried at 120° C. until the moisture content was reduced to 1%, sieved, and then pre-sintered by being heated to 800° C. at 1.5° C./min and held for 8 h, so as to obtain the first microwave ferrite material; for the pre-sintering, an oxygen introduction was started when the temperature reached the pre-sintering temperature; for the pre-sintering, the oxygen introduction was stopped when the temperature was 150° C. lower than the pre-sintering temperature.

### Example 2

This example provides a microwave ferrite material for a 5G radio frequency device, raw materials for preparing the microwave ferrite material comprise a first microwave ferrite material and a second microwave ferrite material; the first microwave ferrite material is: Y_{(3-a-b)}BiₐCa_{b}Fe_{(5-c-d-e-f)}Nb_{c}Zr_{d}InₑMn_{f}O₁₂, wherein a=0.2, b=0.3, c=0.15, d=0.2, e=0.2, and f=0.2; the second microwave ferrite material is: Y_{(3-g-h)}Gd_{g}CaₕFe₍₅₋ᵢ₋ⱼ₋ₖ₋ₙ₎VᵢGeⱼInₖTiₙO₁₂, wherein g=0.3, h=0.6, i=0.15, j=0.2, k=0.2, and n=0.1.

A preparation method for the microwave ferrite material comprises the following steps:
(1) the first microwave ferrite material and the second microwave ferrite material were mixed in a mass ratio of 1:1, and subjected to wet ball milling at 40 r/min for 22 h to obtain a mixture; a mass ratio of powder material to zirconium balls to deionized water in the wet ball milling was 1:1.5:1.5; the mixture obtained had a particle size: D50: 0.8 μm, D90: 1.5 μm, and D99: 2.5 μm;
(2) the mixture obtained in step (1) was dried at 115° C. until the moisture content was reduced to 2%, sieved, and then granulated; the granulation was a process that the sieved mixture was mixed with a 10 wt % aqueous solution of polypropylene alcohol, wherein the mass of the aqueous solution of polypropylene alcohol was 8 wt % of the mass of the dried mixture, and then sieved under a pressure of 900 kg/cm² with a 80-mesh screen, so as to obtain a ferrite powder; and
(3) the ferrite powder in step (2) was sequentially molded and sintered to obtain the microwave ferrite material for a 5G radio frequency device; the molding had a density of 3.8 g/cm³; the sintering was heating to 1350° C. at a heating rate of 2.5° C./min and holding for 15 h; for the sintering, an oxygen introduction was started 2 h before the temperature holding ended; for the sintering, the oxygen introduction was stopped when the temperature was 200° C. lower than the sintering temperature;
   the first microwave ferrite material in step (1) is prepared by the following method:
(a) a first raw material (Y₂O₃, CaCO₃, Fe₂O₃, ZrO₂, MnCO₃, InO₂, Bi₂O₃, and Nb₂O₅) were mixed in formula proportions, and subjected to wet ball milling at 40 r/min for 22 h to obtain a mixture; a mass ratio of the first raw material to zirconium balls to deionized water to ammonium citrate in the wet ball milling was 1:1.5:1.5:0.004; the mixture had a particle size: D50: 8 μm, D90: 1.5 μm, and D99: 2.5 μm; and
(b) the mixture obtained in step (a) was dried at 115° C. until the moisture content was reduced to 2%, sieved, and then pre-sintered by being heated to 650° C. at 1.2° C./min and held for 10 h, so as to obtain the first microwave ferrite material; for the pre-sintering, an oxygen introduction was started when the temperature reached the pre-sintering temperature; for the pre-sintering, the oxygen introduction was stopped when the temperature was 120° C. lower than the pre-sintering temperature;
   the second microwave ferrite material in step (1) is prepared by the following method:
(I) a second raw material (Y₂O₃, CaCO₃, Fe₂O₃, Gd₂O₃, GeO₂, InO₂, TiO₂, and V₂O₅) were mixed in formula proportions, and subjected to wet ball milling at 40 r/min for 22 h to obtain a mixture; a mass ratio of the second raw material to zirconium balls to deionized water to ammonium citrate in the wet ball milling was 1:1.5:1.5:0.004; the mixture had a particle size: D50: 8 μm, D90: 1.5 μm, and D99: 2.5 μm; and
(II) the mixture obtained in step (I) was dried at 115° C. until the moisture content was reduced to 2%, sieved, and then pre-sintered by being heated to 650° C. at 1.2° C./min and held for 10 h, so as to obtain the first microwave ferrite material; for the pre-sintering, an oxygen introduction was started when the temperature reached the pre-sintering temperature; for the pre-sintering, the oxygen introduction was stopped when the temperature was 120° C. lower than the pre-sintering temperature.

### Example 3

This example provides a microwave ferrite material for a 5G radio frequency device, raw materials for preparing the microwave ferrite material comprise a first microwave ferrite material and a second microwave ferrite material; the first microwave ferrite material is: Y_{(3-a-b)}BiₐCa_{b}Fe_{(5-c-d-e-f)}Nb_{c}Zr_{d}InₑMn_{f}O₁₂, wherein a=0.4, b=0.2, c=0.2, d=0.1, e=0.4, and f=0.3; the second microwave ferrite material is: Y_{(3-g-h)}Gd_{g}CaₕFe₍₅₋ᵢ₋ⱼ₋ₖ₋ₙ₎VᵢGeⱼInₖTiₙO₁₂, wherein g=0.5, h=1.1, i=0.25, j=0.4, k=0.2, and n=0.2.

A preparation method for the microwave ferrite material comprises the following steps:
(1) the first microwave ferrite material and the second microwave ferrite material were mixed in a mass ratio of 1:1, and subjected to wet ball milling at 60 r/min for 18 h to obtain a mixture; a mass ratio of powder material to zirconium balls to deionized water in the wet ball milling was 1:2:2; the mixture obtained had a particle size: D50: 1.5 μm, D90: 2.5 μm, and D99: 3 μm;
(2) the mixture obtained in step (1) was dried at 125° C. until the moisture content was reduced to 0.5%, sieved, and then granulated; the granulation was a process that the sieved mixture was mixed with a 15 wt % aqueous solution of polypropylene alcohol, wherein the mass of the aqueous solution of polypropylene alcohol was 12 wt % of the mass of the dried mixture, and then sieved under a pressure of 500 kg/cm² with a 50-mesh screen, so as to obtain a ferrite powder; and
(3) the ferrite powder in step (2) was sequentially molded and sintered to obtain the microwave ferrite material for a 5G radio frequency device; the molding had a density of 3.2 g/cm³; the sintering was heating to 1450° C. at a heating rate of 4° C./min and holding for 9 h; for the sintering, an oxygen introduction was started 4 h before the temperature holding ended; for the sintering, the oxygen introduction was stopped when the temperature was 400° C. lower than the sintering temperature;
   the first microwave ferrite material in step (1) is prepared by the following method:
(a) a first raw material (Y₂O₃, CaCO₃, Fe₂O₃, ZrO₂, MnCO₃, InO₂, Bi₂O₃, and Nb₂O₅) were mixed in formula proportions, and subjected to wet ball milling at 60 r/min for 18 h to obtain a mixture; a mass ratio of the first raw material to zirconium balls to deionized water to ammonium citrate in the wet ball milling was 1:2:2:0.007; the mixture had a particle size: D50: 1.5 μm, D90: 2.5 μm, and D99: 3 μm; and
(b) the mixture obtained in step (a) was dried at 125° C. until the moisture content was reduced to 0.5%, sieved, and then pre-sintered by being heated to 950° C. at 1.8° C./min and held for 5 h, so as to obtain the first microwave ferrite material; for the pre-sintering, an oxygen introduction was started when the temperature reached the pre-sintering temperature; for the pre-sintering, the oxygen introduction was stopped when the temperature was 180° C. lower than the pre-sintering temperature;
   the second microwave ferrite material in step (1) is prepared by the following method:
(I) a second raw material (Y₂O₃, CaCO₃, Fe₂O₃, Gd₂O₃, GeO₂, InO₂, TiO₂, and V₂O₅) were mixed in formula proportions, and subjected to wet ball milling at 60 r/min for 18 h to obtain a mixture; a mass ratio of the second raw material to zirconium balls to deionized water to ammonium citrate in the wet ball milling was 1:2:2:0.007; the mixture had a particle size: D50: 1.5 μm, D90: 2.5 μm, and D99: 3 μm; and
(II) the mixture obtained in step (I) was dried at 125° C. until the moisture content was reduced to 0.5%, sieved, and then pre-sintered by being heated to 950° C. at 1.8° C./min and held for 5 h, so as to obtain the first microwave ferrite material; for the pre-sintering, an oxygen introduction was started when the temperature reached the pre-sintering temperature; for the pre-sintering, the oxygen introduction was stopped when the temperature was 180° C. lower than the pre-sintering temperature.

### Example 4

This example provides a microwave ferrite material for a 5G radio frequency device, raw materials for preparing the microwave ferrite material comprise a first microwave ferrite material and a second microwave ferrite material; the first microwave ferrite material is: Y_{(3-a-b)}BiₐCa_{b}Fe_{(5-c-d-e-f)}Nb_{c}Zr_{d}InₑMn_{f}O₁₂, wherein a=0.1, b=0.8, c=0.25, d=0.4, e=0.1, and f=0.1; the second microwave ferrite material is: Y_{(3-g-h)}Gd_{g}CaₕFe₍₅₋ᵢ₋ⱼ₋ₖ₋ₙ₎VᵢGeⱼInₖTiₙO₁₂, wherein g=0.2, h=0.7, i=0.1, j=0.1, k=0.1, and n=0.4.

A preparation method for the microwave ferrite material comprises the following steps:
(1) the first microwave ferrite material and the second microwave ferrite material were mixed in a mass ratio of 1:1, and subjected to wet ball milling at 30 r/min for 25 h to obtain a mixture; a mass ratio of powder material to zirconium balls to deionized water in the wet ball milling was 1:3:0.6; the mixture obtained had a particle size: D50: 0.02 μm, D90: 0.05 μm, and D99: 0.1 μm;
(2) the mixture obtained in step (1) was dried at 110° C. until the moisture content was reduced to 5%, sieved, and then granulated; the granulation was a process that the sieved mixture was mixed with a 5 wt % aqueous solution of polypropylene alcohol, wherein the mass of the aqueous solution of polypropylene alcohol was 5 wt % of the mass of the dried mixture, and then sieved under a pressure of 1200 kg/cm² with a 100-mesh screen, so as to obtain a ferrite powder; and
(3) the ferrite powder in step (2) was sequentially molded and sintered to obtain the microwave ferrite material for a 5G radio frequency device; the molding had a density of 4 g/cm³; the sintering was heating to 1300° C. at a heating rate of 2° C./min and holding for 20 h; for the sintering, an oxygen introduction was started 1 h before the temperature holding ended; for the sintering, the oxygen introduction was stopped when the temperature was 100° C. lower than the sintering temperature;
   the first microwave ferrite material in step (1) is prepared by the following method:
(a) a first raw material (Y₂O₃, CaCO₃, Fe₂O₃, ZrO₂, MnCO₃, InO₂, Bi₂O₃, and Nb₂O₅) were mixed in formula proportions, and subjected to wet ball milling at 30 r/min for 25 h to obtain a mixture; a mass ratio of the first raw material to zirconium balls to deionized water to ammonium citrate in the wet ball milling was 1:3:0.6:0.003; the mixture had a particle size: D50: 0.02 μm, D90: 0.05 μm, and D99: 0.1 μm; and
(b) the mixture obtained in step (a) was dried at 110° C. until the moisture content was reduced to 5%, sieved, and then pre-sintered by being heated to 560° C. at 1° C./min and held for 12 h, so as to obtain the first microwave ferrite material; for the pre-sintering, an oxygen introduction was started when the temperature reached the pre-sintering temperature; for the pre-sintering, the oxygen introduction was stopped when the temperature was 100° C. lower than the pre-sintering temperature;
   the second microwave ferrite material in step (1) is prepared by the following method:
(I) a second raw material (Y₂O₃, CaCO₃, Fe₂O₃, Gd₂O₃, GeO₂, InO₂, TiO₂, and V₂O₅) were mixed in formula proportions, and subjected to wet ball milling at 30 r/min for 25 h to obtain a mixture; a mass ratio of the second raw material to zirconium balls to deionized water to ammonium citrate in the wet ball milling was 1:3:0.6:0.003; the mixture had a particle size: D50: 0.02 μm, D90: 0.05 μm, and D99: 0.1 μm; and
(II) the mixture obtained in step (I) was dried at 110° C. until the moisture content was reduced to 5%, sieved, and then pre-sintered by being heated to 560° C. at 1° C./min and held for 12 h, so as to obtain the first microwave ferrite material; for the pre-sintering, an oxygen introduction was started when the temperature reached the pre-sintering temperature; for the pre-sintering, the oxygen introduction was stopped when the temperature was 100° C. lower than the pre-sintering temperature.

### Example 5

This example provides a microwave ferrite material for a 5G radio frequency device, raw materials for preparing the microwave ferrite material comprise a first microwave ferrite material and a second microwave ferrite material; the first microwave ferrite material is: Y_{(3-a-b)}BiₐCa_{b}Fe_{(5-c-d-e-f)}Nb_{c}Zr_{d}InₑMn_{f}O₁₂, wherein a=0.5, b=0.6, c=0.3, d=0.6, e=0.6, and f=0.6; the second microwave ferrite material is: Y_{(3-g-h)}Gd_{g}CaₕFe₍₅₋ᵢ₋ⱼ₋ₖ₋ₙ₎VᵢGeⱼInₖTiₙO₁₂, wherein g=0.1, h=1.8, i=0.3, j=0.6, k=0.6, and n=0.6.

A preparation method for the microwave ferrite material comprises the following steps:
(1) the first microwave ferrite material and the second microwave ferrite material were mixed in a mass ratio of 1:1, and subjected to wet ball milling at 70 r/min for 15 h to obtain a mixture; a mass ratio of powder material to zirconium balls to deionized water in the wet ball milling was 1:5:2.5; the mixture obtained had a particle size: D50: 2 μm, D90: 3.5 μm, and D99: 4 μm;
(2) the mixture obtained in step (1) was dried at 130° C. until the moisture content was reduced to 0.05%, sieved, and then granulated; the granulation was a process that the sieved mixture was mixed with a 20 wt % aqueous solution of polypropylene alcohol, wherein the mass of the aqueous solution of polypropylene alcohol was 15 wt % of the mass of the dried mixture, and then sieved under a pressure of 300 kg/cm² with a 30-mesh screen, so as to obtain a ferrite powder; and
(3) the ferrite powder in step (2) was sequentially molded and sintered to obtain the microwave ferrite material for a 5G radio frequency device; the molding had a density of 3.5 g/cm³; the sintering was heating to 1500° C. at a heating rate of 5° C./min and holding for 6 h; for the sintering, an oxygen introduction was started 6 h before the temperature holding ended; for the sintering, the oxygen introduction was stopped when the temperature was 500° C. lower than the sintering temperature;
   the first microwave ferrite material in step (1) is prepared by the following method:
(a) a first raw material (Y₂O₃, CaCO₃, Fe₂O₃, ZrO₂, MnCO₃, InO₂, Bi₂O₃, and Nb₂O₅) were mixed in formula proportions, and subjected to wet ball milling at 70 r/min for 15 h to obtain a mixture; a mass ratio of the first raw material to zirconium balls to deionized water to ammonium citrate in the wet ball milling was 1:5:2.5:0.01; the mixture had a particle size: D50: 2 μm, D90: 3.5 μm, and D99: 4 μm; and
(b) the mixture obtained in step (a) was dried at 130° C. until the moisture content was reduced to 0.05%, sieved, and then pre-sintered by being heated to 1100° C. at 2° C./min and held for 2 h, so as to obtain the first microwave ferrite material; for the pre-sintering, an oxygen introduction was started when the temperature reached the pre-sintering temperature; for the pre-sintering, the oxygen introduction was stopped when the temperature was 200° C. lower than the pre-sintering temperature;
   the second microwave ferrite material in step (1) is prepared by the following method:
(I) a second raw material (Y₂O₃, CaCO₃, Fe₂O₃, Gd₂O₃, GeO₂, InO₂, TiO₂, and V₂O₅) were mixed in formula proportions, and subjected to wet ball milling at 70 r/min for 15 h to obtain a mixture; a mass ratio of the second raw material to zirconium balls to deionized water to ammonium citrate in the wet ball milling was 1:5:2.5:0.01; the mixture had a particle size: D50: 2 μm, D90: 3.5 μm, and D99: 4 μm; and
(II) the mixture obtained in step (I) was dried at 130° C. until the moisture content was reduced to 0.05%, sieved, and then pre-sintered by being heated to 1100° C. at 2° C./min and held for 2 h, so as to obtain the first microwave ferrite material; for the pre-sintering, an oxygen introduction was started when the temperature reached the pre-sintering temperature; for the pre-sintering, the oxygen introduction was stopped when the temperature was 200° C. lower than the pre-sintering temperature.

### Example 6

This example provides a microwave ferrite material for a 5G radio frequency device, and a preparation method for the microwave ferrite material is the same as that in Example 1 except that the mass ratio of the first microwave ferrite material to the second microwave ferrite material in step (1) is changed to 0.5:1.

### Example 7

This example provides a microwave ferrite material for a 5G radio frequency device, and a preparation method for the microwave ferrite material is the same as that in Example 1 except that the mass ratio of the first microwave ferrite material to the second microwave ferrite material in step (1) is changed to 2:1.

### Example 8

This example provides a microwave ferrite material for a 5G radio frequency device, and a preparation method for the microwave ferrite material is the same as that in Example 1 except that the mass ratio of the first microwave ferrite material to the second microwave ferrite material in step (1) is changed to 0.1:1.

### Example 9

This example provides a microwave ferrite material for 5G radio frequency devices, and a preparation method for the microwave ferrite material is the same as that in Example 1 except that the mass ratio of the first microwave ferrite material to the second microwave ferrite material in step (1) is changed to 2.5:1.

### Example 10

This example provides a microwave ferrite material for a 5G radio frequency device, and a preparation method for the microwave ferrite material is the same as that in Example 1 except that the sintering temperature in step (3) is changed to 1200° C.

### Example 11

This example provides a microwave ferrite material for a 5G radio frequency device, and a preparation method for the microwave ferrite material is the same as that in Example 1 except that the sintering temperature in step (3) is changed to 1600° C.

### Comparative Example 1

This comparative example provides a microwave ferrite material for a 5G radio frequency device; except that the first microwave ferrite material is changed to Y_{(3-a-b)}LaₐCa_{b}Fe_{(5-c-d-e-f)}Nb_{c}Zr_{d}InₑMn_{f}O₁₂, wherein a=0.3, b=0.45, c=0.1, d=0.3, e=0.3, and f=0.05, and in the raw materials for preparing the first microwave ferrite material, Bi₂O₃ is adaptively replaced with La₂O₃, others are the same as in Example 1.

### Comparative Example 2

This comparative example provides a microwave ferrite material for a 5G radio frequency device; except that the first microwave ferrite material is changed to Y_{(3-a-b)}BiₐCa_{b}Fe_{(5-c-d-e-f)}Al_{c}Zr_{d}InₑMn_{f}O₁₂, wherein a=0.3, b=0.25, c=0.1, d=0.3, e=0.3, and f=0.05, and in the raw materials for preparing the first microwave ferrite material, Nb₂O₅ is adaptively replaced with Al₂O₃, others are the same as in Example 1.

### Comparative Example 3

This comparative example provides a microwave ferrite material for a 5G radio frequency device; except that the second microwave ferrite material is changed to Y_{(3-g-h)}Dy_{g}CaₕFe₍₅₋ᵢ₋ⱼ₋ₖ₋ₙ₎VᵢGeⱼInₖTiₙO₁₂, wherein g=0.4, h=0.75, i=0.2, j=0.3, k=0.3, and n=0.05, and in the raw materials for preparing the second microwave ferrite material, Gd₂O₃ is adaptively replaced with Dy₂O₃, others are the same as in Example 1.

### Comparative Example 4

This comparative example provides a microwave ferrite material for a 5G radio frequency device; except that the second microwave ferrite material is changed to Y_{(3-g-h)}Gd_{g}CaₕFe₍₅₋ᵢ₋ⱼ₋ₖ₋ₙ₎GaᵢGeⱼInₖTiₙO₁₂, wherein g=0.4, h=0.35, i=0.2, j=0.3, k=0.3, and n=0.05, and in the raw materials for preparing the second microwave ferrite material, V₂O₅ is adaptively replaced with Ga₂O₃, others are the same as in Example 1.

### Comparative Example 5

This comparative example provides a microwave ferrite material for 5G radio frequency devices, and the raw material for the microwave ferrite material is only the first microwave ferrite material in Example 1.

A preparation method for the microwave ferrite material comprises the following steps:
(1) the first microwave ferrite material obtained in Example 1 was subjected to wet ball milling at 50 r/min for 20 h to obtain a ball-milled material; a mass ratio of the powder material to zirconium balls to deionized water in the wet ball milling was 1:1:0.8; the ball-milled material obtained had a particle size: D50: 1 μm, D90: 2 μm, and D99: 3.2 μm;
(2) the ball-milled material obtained in step (1) was dried at 120° C. until the moisture content was reduced to 1%, sieved, and then granulated; the granulation was a process that the sieved ball-milled material was mixed with a 12 wt % aqueous solution of polypropylene alcohol, wherein the mass of the aqueous solution of polypropylene alcohol was 10 wt % of the mass of the dried ball-milled material, and then sieved under a pressure of 700 kg/cm² with a 60-mesh screen, so as to obtain a ferrite powder; and
(3) the ferrite powder in step (2) was sequentially molded and sintered to obtain the microwave ferrite material for a 5G radio frequency device; the molding had a density of 3.5 g/cm³; the sintering was heating to 1400° C. at a heating rate of 3° C./min and holding for 12 h; for the sintering, an oxygen introduction was started 3 h before the temperature holding ended; for the sintering, the oxygen introduction was stopped when the temperature was 300° C. lower than the sintering temperature.

### Comparative Example 6

This comparative example provides a microwave ferrite material for a 5G radio frequency device, and the raw material for the microwave ferrite material is only the second microwave ferrite material in Example 1.

A preparation method for the microwave ferrite material comprises the following steps:
(1) the second microwave ferrite material obtained in Example 1 was subjected to wet ball milling at 50 r/min for 20 h to obtain a ball-milled material; a mass ratio of the powder material to zirconium balls to deionized water in the wet ball milling was 1:1:0.8; the ball-milled material obtained had a particle size: D50: 1 μm, D90: 2 μm, and D99: 3.2 μm;
(2) the ball-milled material obtained in step (1) was dried at 120° C. until the moisture content was reduced to 1%, sieved, and then granulated; the granulation was a process that the sieved ball-milled material was mixed with a 12 wt % aqueous solution of polypropylene alcohol, wherein the mass of the aqueous solution of polypropylene alcohol was 10 wt % of the mass of the dried ball-milled material, and then sieved under a pressure of 700 kg/cm² with a 60-mesh screen, so as to obtain a ferrite powder; and
(3) the ferrite powder in step (2) was sequentially molded and sintered to obtain the microwave ferrite material for a 5G radio frequency device; the molding had a density of 3.5 g/cm³; the sintering was heating to 1400° C. at a heating rate of 3° C./min and holding for 12 h; for the sintering, an oxygen introduction was started 3 h before the temperature holding ended; for the sintering, the oxygen introduction was stopped when the temperature was 300° C. lower than the sintering temperature.

### Performance Test

The microwave ferrite materials for a 5G radio frequency device provided in Examples 1-11 and Comparative Examples 1-6 were subjected to grinding process and tested for the saturation magnetization 4πMs, dielectric constant, dielectric loss, density, ferromagnetic resonance linewidth, and Curie temperature. The samples were processed into Φ2.5 mm spheres to test the saturation magnetization 4πMs and Curie temperature; the density of the samples was determined by water displacement method; the dielectric constant was tested according to IEC60556 standard at a frequency of 10.7 GHz, and the samples were cylinder with a size of 1.6 mm; the ferromagnetic resonance linewidth was tested according to the standard of GB/T 9633-88; the results obtained are shown in Table 1.

TABLE 1

| | Saturation | | Dielectric | | Curie | Resonance |
|---|---|---|---|---|---|---|
| | magnetization | Dielectric | loss tgδₑ | Density | temperature | linewidth |
| | 4πMs (Gs) | constant ε | (×10⁻⁴) | ρ | (° C.) | ΔH (Oe) |
| Example 1 | 1860 | 14.8 | 1.2 | 5.4 | 275 | 12 |
| Example 2 | 1855 | 14.5 | 1.52 | 5.1 | 270 | 10 |
| Example 3 | 1856 | 14.6 | 1.8 | 5.2 | 272 | 12 |
| Example 4 | 1852 | 14 | 1.58 | 5 | 265 | 15 |
| Example 5 | 1854 | 15 | 1.6 | 5.3 | 260 | 16 |
| Example 6 | 1850 | 14 | 1.6 | 5.1 | 262 | 15 |
| Example 7 | 1848 | 13.8 | 1.8 | 5.2 | 265 | 18 |
| Example 8 | 1835 | 13.8 | 2 | 4.6 | 255 | 21 |
| Example 9 | 1830 | 14 | 2.2 | 4.5 | 250 | 23 |
| Example 10 | 1855 | 13.8 | 2 | 5.1 | 268 | 21 |
| Example 11 | 1853 | 14 | 2.1 | 5.2 | 270 | 23 |
| Comparative | 1650 | 14 | 5 | 4.8 | 180 | 40 |
| Example 1 | | | | | | |
| Comparative | 1720 | 13.2 | 4.5 | 4.7 | 205 | 35 |
| Example 2 | | | | | | |
| Comparative | 1635 | 13.5 | 5 | 4.6 | 195 | 36 |
| Example 3 | | | | | | |
| Comparative | 1728 | 13.5 | 4.2 | 4.7 | 225 | 32 |
| Example 4 | | | | | | |
| Comparative | 1745 | 14 | 4 | 5 | 230 | 28 |
| Example 5 | | | | | | |
| Comparative | 1740 | 14 | 4 | 4.8 | 228 | 30 |
| Example 6 | | | | | | |

In summary, the present application adopts a two-component microwave ferrite material formulation, the addition of Bi³⁺ can improve the dielectric constant of the material while lowering the Curie temperature; the addition of Nb⁵⁺ to replace Fe³⁺ promotes the substitution of Y³⁺ with Bi³⁺ and inhibits the generation of other phases; the substitution of Fe³⁺ with V⁵⁺ and the substitution of Y³⁺ with Gd³⁺ can improve the saturation magnetization 4πMs without lowering the Curie temperature; with respect to the preparation method for the microwave ferrite material provided in the present application, by controlling the parameters of ball milling process, the bonding strength of the ferrite powder is improved, the porosity of the ferrite material is reduced, and the resonance linewidth of the microwave ferrite material ultimately obtained is reduced; the proper sintering temperature adjusted can prevent the grains from excessive growth which may be caused by an overly high sintering temperature and overly long period, and is conducive to the formation of microwave ferrite material with good grain size distribution; the microwave ferrite material provided in the present application can satisfy the miniaturization and lightweight requirements of 5G radio frequency devices, the saturation magnetization 4πMs reaches up to 1860 Gs, the dielectric constant ε is 13.8 or more, the dielectric loss tgδₑ is less than or equal to 2.2×10⁻⁴, the Curie temperature reaches up to 275° C., and the resonance linewidth ΔH is no more than 23 Oe.

The above content is only specific embodiments of the present application, and the protection scope of the present application is not limited thereto. It should be clear to those skilled in the art that any changes or substitutions which are obvious to those skilled in the art within the technical scope disclosed by the present application shall all fall within the protection scope and disclosure scope of the present application.

What is claimed is:

1. A microwave ferrite material for a 5G radio frequency device, wherein raw materials for preparing the microwave ferrite material comprise a first microwave ferrite material and a second microwave ferrite material;
the first microwave ferrite material is: Y_{(3-a-b)}BiₐCa_{b}Fe_{(5-c-d-e-f)}Nb_{c}Zr_{d}InₑMn_{f}O₁₂, wherein 0<a≤0.5, 0<b<1.2, 0<c≤0.3, 0<d≤0.6, 0<e≤0.6, and 0<f≤0.6, and b=2c+d−f;
the second microwave ferrite material is: Y_{(3-g-h)}Gd_{g}CaₕFe₍₅₋ᵢ₋ⱼ₋ₖ₋ₙ₎VᵢGeⱼInₖTiₙO₁₂, wherein 0<g≤0.5, 0<h≤1.8, 0<i≤0.3, 0<j≤0.6, 0<k≤0.6, and 0<n≤0.6, and h=2i+j+n.

2. The microwave ferrite material according to claim 1, wherein a mass ratio of the first microwave ferrite material to the second microwave ferrite material is (0.5-2):1.

3. A preparation method for the microwave ferrite material according to claim 1, comprising the following steps:
(1) mixing the first microwave ferrite material and the second microwave ferrite material in formula proportions, and performing wet ball milling, so as to obtain a mixture;
(2) subjecting the mixture obtained in step (1) to drying, sieving, and granulation sequentially to obtain a ferrite powder; and
(3) subjecting the ferrite powder obtained in step (2) to molding and sintering sequentially to obtain the microwave ferrite material for a 5G radio frequency device.

4. The preparation method according to claim 3, wherein a mass ratio of the powder to grinding balls to a grinding aid in the wet ball milling in step (1) is 1:(1-5):(0.6-2.5).

5. The preparation method according to claim 3, wherein the wet ball milling in step (1) is performed for a period of 15-25 h.

6. The preparation method according to claim 3, wherein the wet ball milling in step (1) is performed at a rotational speed of 30-70 r/min.

7. The preparation method according to claim 4, wherein the grinding balls comprise zirconium balls and/or steel balls;
preferably, the grinding aid comprises any one or a combination of at least two of deionized water, ethanol, acetone, n-propanol, or aqueous ammonia.

8. The preparation method according to claim 3, wherein the mixture in step (1) has a particle size range: D50: 0.005-2 μm, D90: 0.05-4 μm, and D99: 0.05-4 μm.

9. The preparation method according to claim 3, wherein the drying in step (2) is performed at a temperature of 110-130° C.;
preferably, the drying in step (2) is stopped when a moisture content is reduced to 0.05-5%;
preferably, the granulation in step (2) is: mixing a sieved mixture with a binder and then performing sieving under a pressure to obtain the ferrite powder;
preferably, a mass of the binder is 5-15 wt % of a mass of the mixture;
preferably, the binder comprises an aqueous solution of polyvinyl alcohol;
preferably, a mass fraction of polyvinyl alcohol is 5-20 wt % in the aqueous solution of polyvinyl alcohol;
preferably, the pressure is 300-1200 kg/cm²;
preferably, the sieving is performed with a screen of 30-100 mesh.

10. The preparation method according to claim 3, wherein the molding in step (3) has a density of 3-4 g/cm³;
preferably, a blank of the molding in step (3) comprises a cylinder or a cube.

11. The preparation method according to claim 3, wherein the first microwave ferrite material in step (1) is prepared by the following method:
(a) mixing a first raw material in formula proportions, and performing wet ball milling to obtain a mixture; and
(b) subjecting the mixture obtained in step (a) to drying, sieving, and pre-sintering sequentially to obtain the first microwave ferrite material;
preferably, a mass ratio of the first raw material to grinding balls to a grinding aid to a dispersant in the wet ball milling in step (a) is 1:(1-5):(0.6-2.5):(0.003-0.01).

12. The preparation method according to claim 11, wherein the wet ball milling in step (a) is performed for a period of 15-25 h;
preferably, the wet ball milling in step (a) is performed at a rotational speed of 30-70 r/min;
preferably, the first raw material in step (a) comprises Y₂O₃, CaCO₃, Fe₂O₃, ZrO₂, MnCO₃, InO₂, Bi₂O₃, and Nb₂O₅;
preferably, the grinding balls comprise zirconium balls and/or steel balls;
preferably, the grinding aid comprises any one or a combination of at least two of deionized water, ethanol, acetone, n-propanol, or aqueous ammonia;
preferably, the dispersant comprises ammonium citrate and/or aqueous ammonia.

13. The preparation method according to claim 3, wherein the second microwave ferrite material in step (1) is prepared by the following method:
(I) mixing a second raw material in formula proportions, and performing wet ball milling to obtain a mixture; and
(II) subjecting the mixture obtained in step (I) to drying, sieving, and pre-sintering sequentially to obtain the second microwave ferrite material.

14. The preparation method according to claim 3, wherein the preparation method comprises the following steps:
(1) mixing the first microwave ferrite material and the second microwave ferrite material in formula proportions, and performing wet ball milling at 30-70 r/min for 15-25 h, so as to obtain a mixture; a mass ratio of powder material to grinding balls to a grinding aid in the wet ball milling is 1:(1-5):(0.6-2.5); the mixture obtained has a particle size range: D50: 0.005-2 μm, D90: 0.05-4 μm, and D99: 0.05-4 μm;
(2) drying the mixture obtained in step (1) at 110-130° C. until a moisture content is reduced to 0.05-5%, sieving and then granulating; the granulation is: mixing a sieved mixture with a binder, and then performing sieving under a pressure of 300-1200 kg/cm² with a screen of 30-100 mesh to obtain a ferrite powder; and
(3) subjecting the ferrite powder obtained in step (2) to molding and sintering sequentially to obtain the microwave ferrite material for a 5G radio frequency device; the molding has a density of 3-4 g/cm³; the sintering is: heating to 1300-1500° C. at a heating rate of 2-5° C./min and holding for 6-20 h; for the sintering, an oxygen introduction is started 1-6 h before the temperature holding ends; for the sintering, the oxygen introduction is stopped when the temperature is 100-500° C. lower than the sintering temperature;
the first microwave ferrite material in step (1) is prepared by the following method:
(a) mixing a first raw material in formula proportions, and performing wet ball milling at 20-80 r/min for 10-40 h to obtain a mixture; a mass ratio of the first raw material to grinding balls to a grinding aid to a dispersant in the wet ball milling is 1:(1-5):(0.6-2.5):(0.003-0.01); the mixture has a particle size range: D50: 0.005-2 μm, D90: 0.05-4 μm, and D99: 0.05-4 μm; and
(b) drying the mixture obtained in step (a) at 110-130° C. until a moisture content is reduced to 0.05-5%, sieving, and then heating to 560-1100° C. at 1-2° C./min to perform pre-sintering and holding for 2-12 h, so as to obtain the first microwave ferrite material; for the pre-sintering, an oxygen introduction is started when the temperature reaches the pre-sintering temperature; for the pre-sintering, the oxygen introduction is stopped when the temperature is 100-200° C. lower than the pre-sintering temperature;
the second microwave ferrite material in step (1) is prepared by the following method:
(I) mixing a second raw material in formula proportions, and performing wet ball milling at 20-80 r/min for 10-40 h to obtain a mixture; a mass ratio of the second raw material to grinding balls to a grinding aid to a dispersant in the wet ball milling is 1:(1-5):(0.6-2.5):(0.003-0.01); the mixture has a particle size range: D50: 0.005-2 μm, D90: 0.05-4 μm, and D99: 0.05-4 μm; and
(II) drying the mixture obtained in step (I) at 110-130° C. until a moisture content is reduced to 0.05-5%, sieving, and then heating to 560-1100° C. at 1-2° C./min to perform pre-sintering and holding for 2-12 h, so as to obtain the second microwave ferrite material; for the pre-sintering, an oxygen introduction is started when the temperature reaches the pre-sintering temperature; for the pre-sintering, the oxygen introduction is stopped when the temperature is 100-200° C. lower than the pre-sintering temperature.

15. The preparation method according to claim 3, wherein the sintering in step (3) is: heating to 1300-1500° C. at a heating rate of 2-5° C./min and holding for 6-20 h.

16. The preparation method according to claim 3, wherein for the sintering in step (3), an oxygen introduction is started 1-6 h before the temperature holding ends;
preferably, for the sintering in step (3), the oxygen introduction is stopped when the temperature is 100-500° C. lower than the sintering temperature.

17. The preparation method according to claim 11, wherein the mixture in step (a) has a particle size range: D50: 0.005-2 μm, D90: 0.05-4 μm, and D99: 0.05-4 μm;
preferably, the drying in step (b) is performed at a temperature of 110-130° C.;
preferably, the drying in step (b) is stopped when a moisture content is reduced to 0.05-5%.

18. The preparation method according to claim 11, wherein the pre-sintering in step (b) is: heating to 560-1100° C. at a heating rate of 1-2° C./min and holding for 2-12 h;
preferably, for the pre-sintering in step (b), an oxygen introduction is started when the temperature reaches the pre-sintering temperature;
preferably, for the pre-sintering in step (b), the oxygen introduction is stopped when the temperature is 100-200° C. lower than the pre-sintering temperature.

19. The preparation method according to claim 13, wherein a mass ratio of the second raw material to grinding balls to a grinding aid to a dispersant in the wet ball milling in step (I) is 1:(1-5):(0.6-2.5):(0.003-0.01);
preferably, the wet ball milling in step (I) is performed for a period of 15-25 h;
preferably, the wet ball milling in step (I) is performed at a rotational speed of 30-70 r/min;
preferably, the second raw material in step (I) comprises Y2O3, CaCO3, Fe2O3, Gd2O3, GeO2, InO2, TiO2, and V2O5;
preferably, the grinding balls comprise zirconium balls and/or steel balls;
preferably, the grinding aid comprises any one or a combination of at least two of deionized water, ethanol, acetone, n-propanol, or aqueous ammonia;
preferably, the dispersant comprises ammonium citrate and/or aqueous ammonia;
preferably, the mixture in step (I) has a particle size range: D50: 0.005-2 μm, D90: 0.05-4 μm, and D99: 0.05-4 μm;
preferably, the drying in step (II) is performed at a temperature of 110-130° C.;
preferably, the drying in step (II) is stopped when a moisture content is reduced to 0.05-5%.

20. The preparation method according claim 13, wherein the pre-sintering in step (II) is: heating to 560-1100° C. at a heating rate of 1-2° C./min and holding for 2-12 h;
preferably, for the pre-sintering in step (II), an oxygen introduction is started when the temperature reaches the pre-sintering temperature;
preferably, for the pre-sintering in step (II), the oxygen introduction is stopped when the temperature is 100-200° C. lower than the pre-sintering temperature.
